(19) United States
(12) Patent Application Publication
(10) Pub. No.: US 2015/0062235 A1
(43) Pub. Date: Mar. 5, 2015

(54) INK JET INK COMPOSITION, INK JET INK SET, AND INK JET RECORDING METHOD

(71) Applicant: Seiko Epson Corporation, Tokyo (JP)

(72) Inventor: Takeshi YANO, Shiojiri (JP)

(21) Appl. No.: 14/330,248

(22) Filed: Jul. 14, 2014

(30) Foreign Application Priority Data
Aug. 30, 2013 (JP) 2013-179110

(51) Int. Cl. C09D 11/322; C08K 5/053; B41J 2/01; C09D 11/38

(52) U.S. Cl. CPC C09D 11/322; C09D 11/38; C08K 5/053; B41J 2/01
USPC 347/20; 524/269; 524/376; 524/389; 524/88

(57) ABSTRACT

An ink jet ink composition includes one or more types selected from a group consisting of water, polymer fine particles, a siloxane-based surfactant, and a fluorine-based surfactant, and an acryl-based surfactant.

### BACKGROUND

1. Technical Field

The present invention relates to an ink jet ink composition, an ink jet ink set, and an ink jet recording method.

2. Related Art

In the ink jet recording method, a high-resolution image can be recorded with a relatively simple apparatus, and rapid development has been achieved in various fields. For example, JP-A-2011-37015 discloses an ink jet recording method in which an image is formed by applying a plurality of different kinds of color inks which include a pigment as a colorant and a clear ink which does not include a colorant on a recording medium, and the amount of the clear ink applied to the unit area is adjusted based on each amount of the respective color inks of the plurality applied to a unit area of the recording medium, in order to provide an ink jet recording method and an ink jet recording apparatus capable of manufacturing a recorded material of which glossiness is excellent and glossiness unevenness is significantly reduced throughout the recorded material.

However, in the ink jet recording method disclosed in JP-A-2011-37015, the obtained glossiness is still insufficient.

### SUMMARY

An advantage of some aspects of the invention is to provide an ink jet ink composition capable of obtaining a recorded material having excellent glossiness, an ink jet ink set including the ink jet ink composition, and an ink jet recording method using the ink jet ink composition.

The present inventors repeated thorough studies. As a result, the inventors found that the above advantage may be achieved by including a predetermined component in the ink jet ink composition, thereby completing the invention.

That is, the invention is as follows.

[1] An ink jet ink composition including water; polymer fine particles; one or more types selected from a group consisting of a siloxane-based surfactant, and a fluorine-based surfactant;

and an acryl-based surfactant.

[2] The ink jet ink composition described in [1], in which a total content of one or more types selected from the group consisting of the siloxane-based surfactant and the fluorine-based surfactant, and the acryl-based surfactant is 0.05% by mass to 5% by mass with respect to 100% by mass of the ink jet ink composition.

[3] The ink jet ink composition described in [1] or [2], in which a ratio of a content of one or more types selected from the group consisting of the siloxane-based surfactant and the fluorine-based surfactant with respect to a content of the acryl-based surfactant is 0.1 to 10.

[4] The ink jet ink composition described in any one of [1] to [3], in which the siloxane-based surfactant includes polyether-modified polydimethylsiloxane.

[5] The ink jet ink composition described in any one of [1] to [4], in which the siloxane-based surfactant includes polyether-modified polydimethylsiloxane represented by the following General Formula (1).

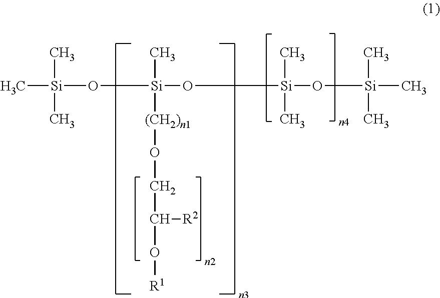

(In Formula (1), R¹ each independently represents a hydrogen atom or an alkyl group having 1 to 4 carbon atoms, R² each independently represents a hydrogen atom or an alkyl group having 1 to 4 carbon atoms, a monovalent group having a cationically polymerizable group or a monovalent group having an ethylenically unsaturated group, n₁ and n₂ each independently is an integer of 1 to 5, n₃ is an integer of 1 to 30, n₄ is an integer of 1 to 70, and n₃/n₄ is less than 1.)

[6] The ink jet ink composition described in any one of [1] to [5], which is a clear ink.

[7] An ink jet ink set having the ink jet ink composition described in [6], water, polymer fine particles, and an ink jet ink composition for coloring including a colorant.

[8] The ink jet ink set described in [7] in which the ink jet ink composition for coloring includes one or more types selected from a group consisting of a siloxane-based surfactant, and a fluorine-based surfactant;

and an acryl-based surfactant.

[9] An ink jet recording method having applying the ink jet ink composition described in any one of [1] to [6] to a recording medium by discharging the ink jet ink composition from nozzles of a head.

[10] The ink jet recording method described in [9], in which the head has a nozzle array in which the nozzles are lined up in a first direction, and in the applying, the head discharges such that a recording resolution (dpi) in the first direction of an image is equal to or less than four times a nozzle density (dpi) in the first direction.

[11] The ink jet recording method described in [9] or [10] having applying a treatment solution including a reactant which aggregates components included in the ink jet ink composition or thickens the ink jet ink composition to the recording medium, before the applying of the ink jet ink composition.

[12] The ink jet recording method described in any one of [9] to [11] in which recording is performed by discharging the ink jet ink composition in an area of the recording medium opposite to the head with one scan of the head with respect to the recording medium.

[13] An ink jet recording method having firstly applying the ink jet ink composition for coloring provided in the ink jet ink set described in [7] or [8] to a recording medium by discharging the ink jet ink composition from nozzles of a first head, and secondly applying the ink jet ink composition which is a clear ink provided to the ink jet ink set to at least a part of the ink jet ink composition for coloring applied to the recording medium by discharging the ink jet ink composition from nozzles of a second head.

[14] The ink jet recording method described in [13], in which the first head and the second head have nozzle arrays in which the nozzles are lined up in the first direction, and a recording resolution (dpi) in the first direction of an image obtained in the secondly applying is equal to or less than four times a nozzle density (dpi) in the first direction of the second head.

[15] The ink jet recording method described in [13] or [14] having applying a treatment solution including a reactant which aggregates components included in the ink jet ink composition for coloring or thickens the ink jet ink composition for coloring to the recording medium, before the firstly applying.

[16] The ink jet recording method described in any one of [13] to [15] in which recording is performed by discharging the ink jet ink composition which is the ink jet ink composition for coloring and the clear ink in an area of the recording medium opposite to the first head and the second head with one scan of the first head and the second head with respect to the recording medium.

### DESCRIPTION OF EXEMPLARY EMBODIMENTS

Hereinafter, embodiment for carrying out the invention (hereinafter, referred to as “the embodiment”) will be described in detail, the invention is not limited thereto, and various modifications are possible without departing from the gist of the invention.

### Ink Jet Ink Composition

The ink jet ink composition (hereinafter, also simply referred to as “ink composition”) according to the embodiment include one or more types (hereinafter, also referred to as “first surfactant”) selected from the group consisting of water, polymer fine particles, a siloxane-based surfactant and a fluorine-based surfactant, and an acryl-based surfactant.

By using the first surfactant in combination with other components included in the ink composition, it is possible to improve repellence and unevenness of the ink droplets when the polymer particles form an ink film on the recording medium. As a result, it is possible to form an ink film with less gaps and irregularities on the recording medium (wet-spreading effect). On the other hand, by using an acryl-based surfactant, it is possible to make the surface layer of the formed ink film smoother (leveling effect). This is because the acryl-based surfactant having a relatively high hydrophobicity is easily localized on the surface of the ink film when the ink film is dried. The acryl-based surfactant localized on the surface of the ink film plays a role of further reducing the unevenness of the surface of the ink film and further providing gloss. As described above, by exhibiting both the wet-spreading effect and the leveling effect, the ink jet ink composition according to the embodiment becomes an ink jet ink composition by which a recorded material with excellent gloss is obtained.

The ink composition according to the embodiment is preferably a clear ink. Here, the “clear ink” is not an ink used for coloring the recording medium but an ink used for other purposes. The purposes are to adjust the glossiness of the recording medium, to improve characteristics such as abrasion resistance of the recorded material, and to improve fixation and coloring property of the color ink. The content of coloring material in the clear ink is preferably equal to or less than 0.1% by mass, and more preferably an ink composition not including the coloring material. In a case where the ink jet ink composition according to the embodiment is used as the clear ink, and other color ink (ink for coloring) is further used, the ink becomes a clear ink which can improve the glossiness of the color ink. Moreover, the “color ink” refers to an ink composition including a coloring material for coloring the recording medium.

### Water

The ink composition according to the present embodiment includes water. Examples of the water include pure water such as ion exchange water, ultrafiltrated water, reverse osmosis water and distilled water, and water in which ionic impurities are removed as much as possible such as ultrapure water. In addition, when water is sterilized by being irradiated with an ultraviolet ray or adding hydrogen peroxide, it is possible to prevent fungi or bacteria from being colonizing when the ink is preserved for a long period of time. Thus, there is a tendency that storage stability is further improved.

The water content is preferably 50% by mass to 90% by mass, more preferably 55% by mass to 80% by mass, and further more preferably 60% by mass to 75% by mass with respect to 100% by mass of the ink composition. When the water content is within the above-described range, there is a tendency that the wet-spreading effect of the first surfactant, and the leveling effect of relatively oily acryl-based surfactant are more excellently exhibited.

### Polymer Fine Particles

The ink composition according to the embodiment includes polymer fine particles. The polymer fine particles contribute to formation of an ink film. As the polymer constituting the polymer fine particles, which are not particularly limited, known polymers may be used. Examples of the polymer include polyacrylic acid ester or a copolymer thereof, polymethacrylic acid ester or a copolymer thereof, polyacrylonitrile or a copolymer thereof, or an acryl-based polymer represented by polycyanoacrylate, polyacrylamide, polyacrylic acid or polymethacrylic acid; polyethylene, polypropylene, polybutene, polyisobutylene, polystyrene or copolymers thereof, or a polyolefin-based polymer represented by a petroleum resin, a coumarone-indene resin or a terpene resin; polyvinyl acetate or a copolymer thereof, or a vinyl acetate-based polymer or a vinyl alcohol-based polymer represented by polyvinyl alcohol, polyvinyl acetal or polyvinyl ether; polyvinyl chloride or a copolymer thereof, or a halogen-containing polymer represented by polyvinylidene chloride, a fluorine resin or a fluororubber; polyvinyl carbazole, polyvinylpyrrolidone or copolymers thereof, or a nitrogen-containing vinyl polymer represented by polyvinyl pyridine or polyvinylimidazole; polybutadiene or a copolymer thereof, or a diene-based polymer represented by polychloroprene or polyisoprene (butyl rubber); other ring-opening polymerization type resins, condensation polymerization type resins, or natural macromolecular resins.

In addition, examples of commercially available polymer fine particles, which are not particularly limited, include HYTEC E-7025P, HYTEC E-2213, HYTEC E-9460, HYTEC E-9015, HYTEC E-4A, HYTEC E-5403P and HYTEC E-8237 (product names, manufactured by Toho Chemical Industry Co., Ltd.), and AQUACER 507, AQUACER 515 and AQUACER 840 (product names, manufactured by BYK Japan KK).

Shape of the polymer fine particles may be fine particle powder, and may be a resin emulsion. In a case where the ink composition is the clear ink, the polymer fine particles form an emulsion in the ink composition to colloid-disperse, transparency of the clear ink composition is increased, and thus there is a tendency that a higher-quality recording image can be obtained.

In a case where the polymer fine particles are obtained in a state of emulsion, it is possible to mix a polymer and a surfactant with water, as necessary. For example, it is possible to obtain an emulsion of a (meth)acryl-based resin or a styrene-(meth)acrylic acid copolymer-based resin by mixing a resin of the (meth)acryl-based resin or the styrene-(meth)acrylic acid copolymer-based resin and a surfactant, with water.

In addition, it is also possible to obtain an resin emulsion by emulsion-polymerizing monomers of the above-described polymer fine particles in water in which a polymerization catalyst and an emulsifier are present.

Examples of the commercially available products of the resin emulsion, which are not particularly limited, include Microgel E-1002, E-5002 (styrene-acryl-based resin emulsion; manufactured by Nippon Paint Co., Ltd.), Voncoat 4001 (acryl-based resin emulsion; manufactured by DIC Corporation), Voncoat 5454 (styrene-acryl-based resin emulsion; manufactured by DIC Corporation), SAE 1014 (styrene-acryl-based resin emulsion; manufactured by ZEON CORPORATION), and Saivinol SK-200 (acryl-based resin emulsion; manufactured by Saiden Chemical Industry Co., Ltd.). The resin emulsions may be used alone or two or more kinds may be used in combination.

From the viewpoint of long-term storage stability and discharging stability of the ink composition, the average particle diameter of the polymer fine particles is in the range of 5 nm to 400 nm, and more preferably in the range of 50 nm to 200 nm. Moreover, the particle diameter of the polymer fine particles is measured by using a laser analysis/scattering type particle size distribution measuring apparatus.

The polymer fine particles may be used alone or two or more kinds may be used in combination.

The content of the polymer fine particles when the ink composition is a clear ink is preferably 0.10% by mass to 15.0% by mass, more preferably 0.50% by mass to 15.0% by mass, further more preferably 1.00% by mass to 15.0% by mass, and particularly preferably 7% by mass to 15% by mass in terms of solid content, with respect to 100% by mass of the ink composition. When the content is equal to or greater than 0.10% by mass, there is a tendency that fixation with respect to the recording medium is further improved, or glossiness of the pattern becomes higher. On the other hand, when the content is equal to or less than 15.0% by mass, there is a tendency that the storage stability and the discharging stability of the ink composition are more excellent.

The content of the polymer fine particles when the ink composition is a color ink is preferably 0.10% by mass to 15.0% by mass, more preferably 0.50% by mass to 10.0% by mass, and further more preferably 0.50% by mass to 5.00% by mass in terms of solid content, with respect to 100% by mass of the ink composition. When the content is equal to or greater than 0.10% by mass, there is a tendency that fixation with respect to the recording medium is further improved. On the other hand, when the content is equal to or less than 15.0% by mass, there is a tendency that the storage stability and the discharging stability of the ink composition are more excellent.

### Siloxane-Based Surfactant

The ink composition according to the embodiment may include a siloxane-based surfactant. By using the siloxane-based surfactant in combination with other components included in the ink composition, it is possible to improve the repellence and unevenness of the ink droplets when an ink film is formed on the recording medium. As a result, it is possible to form an ink film with less gaps and irregularities on the recording medium. In this manner, by the ink film with less gaps and irregularities, gloss of the obtained recorded material is improved. In particular, the siloxane-based surfactant exhibits excellent wettability with respect to a low-absorbent recording medium and a non-absorbent recording medium. Therefore, by using the siloxane-based surfactant, it is possible to further improve the repellence and unevenness of the ink droplets when an ink film is formed on the low-absorbent recording medium and the non-absorbent recording medium, and it is possible to obtain excellent gloss.

The siloxane-based surfactant preferably includes polyether-modified polydimethylsiloxane. As the polyether-modified polydimethylsiloxane, which is not particularly limited, polyether-modified polydimethylsiloxane represented by the following General Formula (1) can be exemplified. By using such a siloxane-based surfactant, there is a tendency that the wet-spreading effect is more excellently exhibited, and gloss of the obtained recorded material is improved. As the polyether-modified polydimethylsiloxane represented by the following General Formula (1), which is not particularly limited, BYK-349 can be exemplified.

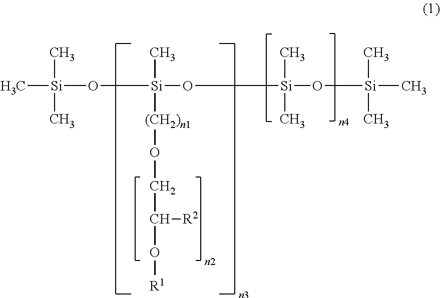

Here, in Formula (1), R¹ each independently represents a hydrogen atom or an alkyl group having 1 to 4 carbon atoms, R² each independently represents a hydrogen atom or an alkyl group having 1 to 4 carbon atoms, a monovalent group having a cationically polymerizable group or a monovalent group having an ethylenically unsaturated group, n₁ and n₂ each independently is an integer of 1 to 5, n₃ is an integer of 1 to 30, n₄ is an integer of 1 to 70, and n₃/n₄ is less than 1.

Examples of the cationically polymerizable group or the ethylenically unsaturated group, which are not particularly limited, include a glycidyl group, an oxetanyl group, a vinyl ether group, a (meth)acryloyl group, and a vinyl group.

Examples of the commercially available products of the siloxane-based surfactant, which are not particularly limited, include BYK-306, BYK-307, BYK-333, BYK-341, BYK-345, BYK-346, BYK-347, BYK-348, and BYK-349 (hereinbefore, product names, manufactured by BYK Japan KK), and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (hereinbefore, product names, manufactured by Shin-Etsu Chemicals Co., Ltd.). Among these, BYK-348 and BYK-349 are preferable.

The siloxane-based surfactant may be used alone or two or more kinds may be used in combination.

The content of the first surfactant is preferably 0.05% by mass to 3.50% by mass, more preferably 0.15% by mass to 3.25% by mass, further more preferably 0.20% by mass to 3.0% by mass, even more preferably 0.05% by mass to 1.50% by mass, particularly preferably 0.10% by mass to 1.25% by mass, still more preferably 0.10% by mass to 1.00% by mass, and further still more preferably 0.50% by mass to 1.00% by mass with respect to 100% by mass of the ink jet ink composition. When the content is within the above-described range, there is a tendency that the ink easily wet-spreads uniformly on the recording medium, printing unevenness and bleeding of the ink can be further suppressed, the storage stability and the discharging stability of the ink composition are more excellent.

### Fluorine-Based Surfactant

The ink composition according to the embodiment may include a fluorine-based surfactant. By using the fluorine-based surfactant in combination with other components included in the ink composition, it is possible to improve the repellence and unevenness of the ink droplets when an ink film is formed on the recording medium. As a result, it is possible to form an ink film with less gaps and irregularities on the recording medium. In particular, the fluorine-based surfactant exhibits excellent wettability with respect to the low-absorbent recording medium and the non-absorbent recording medium. Therefore, by using the fluorine-based surfactant, it is possible to further improve the repellence and unevenness of the ink droplets when an ink film is formed on the low-absorbent recording medium and the non-absorbent recording medium, and it is possible to obtain excellent gloss.

As the fluorine-based surfactant, which is not particularly limited, known fluorine-based surfactants may be used. Examples of the fluorine-based surfactant include a perfluoroalkyl sulfonic acid compound, a perfluoroalkyl carboxylic compound, a perfluoroalkyl phosphoric acid ester compound, and a polyoxyalkylene ether polymer compound having a perfluoroalkyl ether group in a side chain.

Examples of the perfluoroalkyl sulfonic acid compound, which are not particularly limited, include perfluoroalkyl sulfonic acid and perfluoroalkyl sulfonate.

Examples of the perfluoroalkyl carboxylic compound, which are not particularly limited, include perfluoroalkyl carboxylic acid and perfluoroalkyl carboxylate.

Examples of the perfluoroalkyl phosphoric acid ester compound, which are not particularly limited, include perfluoroalkyl phosphoric acid ester and salts of perfluoroalkyl phosphoric acid ester.

Examples of the polyoxyalkylene ether polymer compound having a perfluoroalkyl ether group in a side chain, which are not particularly limited, include a polyoxyalkylene ether polymer having a perfluoroalkyl ether group in a side chain, sulfuric acid ester salts of a polyoxyalkylene ether polymer having a perfluoroalkyl ether group in a side chain, and salts of polyoxyalkylene ether polymer having a perfluoroalkyl ether group in a side chain.

In a case where the fluorine-based surfactant has a perfluoroalkyl group, the number of carbon atoms in the perfluoroalkyl group, which is not particularly limited, is preferably 2 to 10, and more preferably 2 to 6. When the number of carbon atom in the perfluoroalkyl group is within the above-described range, it is possible to further improve the repellence and unevenness of the ink droplets when an ink film is formed, and it is possible to obtain excellent gloss.

Among these fluorine-based surfactants, FS-300 and the like are preferable from the viewpoint of further improving the repellence and unevenness of the ink droplets.

Examples of counter ions of the salt in these fluorine-based surfactants include Li, Na, K, NH₄, NH₃CH₂CH₂OH, NH₂ (CH₂CH₂OH)₂, and NH(CH₂CH₂OH)₃.

Examples of commercially available fluorine-based surfactants, which are not particularly limited, include Surflon 5-111, S-112, S-113, S-121, S-131, S-132, S-141, S-144, S-145 (hereinbefore, manufactured by Asahi Glass Co., Ltd.), Fluorad FC-93, FC-95, FC-98, FC-129, FC-135, FC-170C, FC-430, FC-431, Florad FC4430 (hereinbefore, manufactured by Sumitomo 3M Ltd.), Megafac F-470, F1405, F-474 (hereinbefore, manufactured by DIC Corporation), Zonyl TBS, FSP, FSA, FSN-100, FSN, FSO-100, FSO, FS-300, UR (hereinbefore, manufactured by DuPont), FT-110, FT-250, FT-251, FT-4005, FT-150, FT-400SW (hereinbefore, manufactured by Neos Company Limited), and PF-151N (manufactured by OMNOVA Solutions Inc.). Among these, Zonyl FS-300, FSN, FSN-100, and FSO (manufactured by DuPont) are preferable. By using such a fluorine-based surfactant, there is a tendency that reliability and coloring are improved.

The fluorine-based surfactant may be used alone or two or more kinds may be used in combination.

### Acryl-Based Surfactant

The ink composition according to the embodiment includes an acryl-based surfactant. When the ink composition includes the acryl-based surfactant with other components, it is possible to make the surface layer of the formed ink film smoother (leveling effect). As the acryl-based surfactant capable of being used, which is not particularly limited, macromolecular surfactants having an acrylic skeleton or a methacrylic skeleton can be exemplified. Moreover, in the specification, “acryl-based surfactant” includes both a surfactant having an acrylic skeleton and a surfactant having a methacrylic skeleton. In addition, in this specification, a surfactant having a siloxane skeleton and an acrylic skeleton or a methacrylic skeleton, and a surfactant having a fluorine atom and an acrylic skeleton or a methacrylic skeleton are included in the siloxane-based surfactant and the fluorine-based surfactant.

Examples of the commercially available products of the acryl-based surfactant, which are not particularly limited, include OX-880EF, OX-881, OX-883, OX-883HF, OX-70, OX-77EF, OX-60, OX-710, OX-720, OX-720EF, OX-750HF, LAP-10, LAP-20, LAP-30, 1970, 230, LF-1970, LF-1980, LF-1982, LF-1983, LF-1984, LF-1985, LHP-95, LHP-96, UVX-35, UVX-36, UVX-39, and AQ-200 (hereinbefore, manufactured by Kusumoto Chemicals, Ltd.), and BYK-350, BYK-352, BYK-354, BYK-355, BYK-358N/361N, BYK-380N, BYK-381, and BYK-392 (hereinbefore, manufactured by BYK Japan KK).

Among these acryl-based surfactants, BYK381 and BYK361N are preferable from the viewpoint of making the surface of the ink film formed be smoother. The acryl-based surfactant may be used alone or two or more kinds may be used in combination.

The content of the acryl-based surfactant is preferably 0.01% by mass to 2.0% by mass, more preferably 0.05% by mass to 1.50% by mass, and further more preferably 0.10% by mass to 1.00% by mass with respect to 100% by mass of the ink jet ink composition. When the content is within the above-described range, there is a tendency that the ink easily wet-spreads uniformly on the recording medium, printing unevenness and bleeding of the ink can be further suppressed, the storage stability and the discharging stability of the ink composition are more excellent.

The total content A of the first surfactant and the acryl-based surfactant is preferably 0.05% by mass to 5.00% by mass, more preferably 0.10% by mass to 4.00% by mass, and further more preferably 0.20% by mass to 3.00% by mass with respect to 100% by mass of the ink jet ink composition. When the total content is equal to or greater than 0.05% by mass, there is a tendency that the wet-spreading property of the ink composition on the recording medium particularly excellent. In addition, when the total content is equal to or less than 5.00% by mass, there is a tendency that the storage stability and the discharging stability are more excellent.

A ratio B of the content of the first surfactant to the content of the acryl-based surfactant is preferably 0.1 to 10, more preferably 0.5 to 10, further more preferably 0.7 to 8, and particularly preferably 2 to 6. When the ratio B is within the above-described range, there is a tendency that the balance of the wet-spreading property and the leveling property are more excellent, the glossiness is further improved, and the storage stability and the discharging stability are more excellent. In addition, when the ratio B is equal to or less than 10, there is a tendency that the glossiness is more excellent.

### Other Components

Hereinafter, other components which can be included in the ink composition according to the embodiment will be listed.

### Penetrating Agent

The ink composition used in the embodiment preferably further contains a penetrating agent. A recorded material in which bleeding of an image is small can be obtained by fast penetration of the ink composition into a recording medium.

As the penetrating agent, which is not particularly limited, alkyl ethers of polyol (glycol ethers) and 1,2-alkyldiol can be preferably exemplified. Examples of the glycol ethers, which are not particularly limited, include ethylene glycol monomethyl ether, ethylene glycol monoethyl ether, ethylene glycol monopropyl ether, ethylene glycol monobutyl ether, ethylene glycol monomethyl ether acetate, diethylene glycol monomethyl ether, diethylene glycol monoethyl ether, diethylene glycol monopropyl ether, diethylene glycol monobutyl ether, diethylene glycol mono-t-butyl ether, triethylene glycol monobutyl ether, 1-methyl-1-methoxy butanol, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, propylene glycol monobutyl ether and dipropylene glycol monobutyl ether. In addition, examples of the 1,2-alkyldiol, which are not particularly limited, include 1,2-pentanediol and 1,2-hexanediol. In addition to these, diols having a linear hydrocarbon such as 1,3-propanediol, 1,4-butanediol, 1,5-pentanediol, 1,6-hexanediol, 1,7-heptanediol and 1,8-octanediol can also be exemplified. Among these, by combination with other components included in the ink composition, it is possible to further suppress the bleeding of an image, and the ink discharging property also becomes more excellent.

The penetrating agent may be used alone or two or more kinds may be used in combination.

### Moisturizing Agent

The ink composition used in the embodiment preferably further includes a moisturizing agent (wetting agent). The moisturizing agent can be used without being particularly limited as long as it is generally used in the ink jet ink. The boiling point of the moisturizing agent is preferably equal to or greater than 180° C., and more preferably equal to or greater than 200° C. When the boiling point is within the above-described range, it is possible to apply an excellent water holding property and wetting property to the ink composition.

Specific examples of the moisturizing agent having a high boiling point, which are not particularly limited, include ethylene glycol, propylene glycol, diethylene glycol, triethylene glycol, pentamethylene glycol, trimethylene glycol, 2-butene-1,4-diol, 2-ethyl-1,3-hexanediol, 2-methyl-2,4-pentanediol, tripropylene glycol, polyethylene glycol having a number average molecular weight of 2,000 or lower, 1,3-propylene glycol, isopropylene glycol, isobutylene glycol, glycerin, meso-erythritol, and pentaerythritol. Among these, in combination with other components included in the ink composition, the propylene glycol is preferable from the viewpoint of exhibiting more excellent action as a moisturizing agent.

The moisturizing agent may be used alone or two or more kinds may be used in combination. When the ink composition includes the moisturizing agent having a high boiling point, it is possible to obtain the ink composition which can maintain fluidity and redispersibility for a long period of time even if the ink is left in a state where the pigment ink is exposed to air in an open state. Furthermore, in such an ink composition, since the clogging of nozzles is unlikely to occur while recording is performed using the ink jet recording apparatus or at the time of being restarted after an interruption, the discharging stability of the ink composition becomes excellent. The content of the moisturizing agent is not particularly limited and may be suitably determined, as necessary.

Moreover, as described above, in the case where the ink composition includes a cyclic amide compound, since the cyclic amide compound has a moisture retaining property, the cyclic amide compound is preferably used as the moisturizing agent.

### Other Components

In the ink composition used in the embodiment, various additives such as a solvent, a resin emulsion, a solubilizer, a viscosity modifier, a pH adjusting agent, an antioxidant, a preservative, an antifungal agent, a corrosion inhibitor, and a chelating agent for capturing metal ions which affect dispersion can be suitably added. The ink composition used in the embodiment is preferably an aqueous ink composition which includes mostly water among volatile components from the viewpoint of safety.

### Ink Jet Recording Method Using Ink Jet Ink Set

An ink jet recording method using the ink jet ink according to the embodiment has a step of applying the ink jet ink composition to a recording medium by discharging the ink jet ink composition from nozzles of a head.

### Pretreatment Step

The ink jet recording method using the ink jet ink according to the embodiment can have a pretreatment step in which a treatment solution including a reactant which aggregates components included in the ink jet ink composition or thickens the ink jet ink composition is applied to the recording medium, before the above-described step. Thus, by having the pretreatment step, it is possible to improve poor embedment (repellence, line unevenness) of a solid image in the low-absorbent recording medium and the non-absorbent recording medium. However, since the pigment or the resin in ink is aggregated by the treatment solution, and by this, the apparent particle diameter increases, the image quality becomes a matte tone. Therefore, by having the pretreatment step before the above-described step, matte toning due to the treatment solution can be reduced, and therefore, the use of the ink composition according to the embodiment is effective. In addition, the use of the ink composition according to the embodiment is also effective from the viewpoint of excellent environmental safety. As the treatment solution applying method to a recording medium of the pretreatment step, methods such an ink jet method, a roller method, a spraying method can be used, and the method is not limited to these examples. Among these, the ink jet method is preferable since it can be applied to any area of the recording medium.

### Treatment Solution

As the treatment solution aggregating or thickening the ink composition is not particularly limited, and a treatment solution which includes at least one of a polyvalent metal salt, an organic acid, and an organic acid salt can be exemplified. By interaction of the polyvalent metal salt, the organic acid, and the organic acid salt in the treatment solution with the ink composition, the ink composition aggregates or thickens. Thus, it is possible to prevent landing interference and bleeding of the ink composition applied thereafter, and it is possible to uniformly draw lines and fine images.

### Polyvalent Metal Salt

As the polyvalent metal salt, which is not particularly limited, a polyvalent metal salt of an inorganic acid or a polyvalent metal salt of an organic acid is preferable. As such a polyvalent metal salt, which is not particularly limited, salts of alkali earth metals belonging to group 2 in the periodic table (for example, magnesium, calcium), transition metals belonging to group 3 in the periodic table (for example, lanthanum), earth metals belonging to group 13 in the periodic table (for example, aluminum), and lanthanides (for example, neodymium) can be exemplified. As these polyvalent metal salts, carboxylate (formate, acetate, and benzoate), sulfate, nitrate, chloride, and thiocyanate are preferable. Among these, a calcium salt or a magnesium salt of carboxylic acid (formic acid, acetic acid, and benzoic acid), a calcium salt or a magnesium salt of sulfuric acid, a calcium salt or a magnesium salt of nitric acid, calcium chloride, magnesium chloride, and a calcium salt or a magnesium salt of thiocyanic acid can be preferably exemplified. Moreover, the polyvalent metal salts may be used singly or in combination of two or more kinds thereof.

### Organic Acid and Salt Thereof

Examples of the organic acid and salts thereof, which are not particularly limited, include phosphoric acid, oxalic acid, malonic acid, succinic acid, and citric acid. Among these, monovalent or bivalent or higher carboxylic acid is preferable. Moreover, the organic acid may be used singly or in combination of two or more kinds thereof.

### Solvent

The solvent is not particularly limited, and for example, an organic solvent or water can be used.

### Recording Resolution

From the viewpoint of obtaining a recorded material with high glossiness, a head has nozzle arrays in which the nozzles are lined up in the first direction, and a recording resolution (dpi) in the first direction of an image obtained in the above-described step is preferably equal to or less than eight times, more preferably equal to or less than four times, and further more preferably equal to or less than two times a nozzle density (dpi) in the first direction. Here, in a case of a line system described below, the above-described first direction is a direction (direction in which the nozzle arrays of a line head extend) intersecting one direction (scanning direction). In addition, in a case of a serial recording system in which recording is performed by a plurality of scans (pass) of a head with respect to a recording medium, the above-described first direction is a direction intersecting the scanning direction (direction in which the nozzle arrays of a head extend). In a case of recording an image with a higher recording resolution than the nozzle density in the first direction, since the number of recording pass of the head is set to be equal to or greater than 2, an image is formed while ink is discretely implanted. As a result, time difference between implantations occurs, ink droplets which begin to be solidified after being discharged, landed, and dried in the previous pass, and ink droplets, which have fluidity in the undried state, discharged and landed in the next pass, in one image are mixed, and thus there is a tendency that irregularities occur on the surface layer of the image, and gloss is reduced (being matted). As the number of pass is increased, gloss is likely to be reduced. When the recording resolution is equal to or less than eight times, since ink droplets are discharged by the small number of pass, there is a tendency that gloss of the obtained recorded material is more excellent.

In addition, from the viewpoint of obtaining an image with a high-resolution, a head has nozzle arrays in which the nozzles are lined up in the first direction, and a recording resolution (dpi) in the first direction of an image obtained in the above-described step is preferably equal to or greater than two times, more preferably equal to or greater than four times, and further more preferably equal to or greater than two times a nozzle density (dpi) in the first direction. When the recording resolution is equal to or greater than two times the nozzle density (dpi) in the first direction, gloss tends to be reduced, and by using the ink composition of the embodiment with excellent glossiness, there is a tendency that an image having high glossiness and a high-resolution is obtained.

From the viewpoint of obtaining a recorded material with high glossiness, a recording resolution (dpi) in the direction (typically, a direction perpendicular to the first direction) intersecting the first direction of the image obtained in the above-described step, which is not particularly limited, is preferably equal to or less than eight times, more preferably equal to or less than four times, and further more preferably equal to or less than two times the nozzle density (dpi) in the first direction. In a case where the resolution in the direction intersecting the first direction of ink droplets discharged by one pass in the above-described step is one time the nozzle density (dpi) in the first direction, as the recording resolution in the direction intersecting the first direction of the image obtained in the above-described step is higher than the nozzle density (dpi) in the first direction, there is a tendency that gloss of the image is reduced. Therefore, in this case, when the recording resolution in the direction intersecting the first direction of the image is within the above-described range, there is a tendency that gloss is further improved.

In addition, from the viewpoint of obtaining an image with a high-resolution, the recording resolution (dpi) in the direction (typically, direction perpendicular to the first direction) intersecting the first direction of the image obtained in the above-described step, which is not particularly limited, is preferably equal to or greater than eight times, more preferably equal to or greater than four times, and further more preferably equal to or greater than two times the nozzle density (dpi) in the first direction. When the recording resolution (dpi) in the direction intersecting the first direction of the image obtained in the above-described step is equal to or greater than two times, there is a tendency that an image with a higher-resolution is obtained.

### Recording Method

While relatively scanning the head in the first direction with respect to the recording medium, recording is preferably carried out by performing one time discharge of the ink jet ink composition in the area of the recording medium opposite to the head. That is, it is preferable to perform recording by the line system in a single pass. When performing recording by the line system, the time difference between implantations becomes smallest, and thus the recording speed tends to be excellent. In a case of the line system, the recording resolution (dpi) in the first direction of an image is usually one time the nozzle density (dpi) in the first direction.

### Recording Medium

The ink composition according to the embodiment can be widely used with respect to an absorbent recording medium, a low-absorbent recording medium, and a non-absorbent recording medium.

Examples of the absorbent recording medium, which are not particularly limited, include plain paper such as electrophotographic paper in which penetrability of the ink composition is high, ink jet paper (paper used exclusively for an ink jet provided with an ink absorbing layer composed of silica particles or alumina particles, or an ink absorbing layer composed of a hydrophilic polymer represented by polyvinyl alcohol (PVA) or polyvinyl pyrrolidone (PVP)), art paper, coated paper, and cast paper used in general offset printing in which penetrability of the ink composition is relatively low.

As the low absorbent recording medium, which is not particularly limited, coated paper provided with a coating layer for receiving oil-based inks on the surface can be exemplified. As the coated paper, which is not particularly limited, actual printing paper represented by art paper, coated paper, and matte paper can be exemplified.

Examples of the non-absorbent recording medium, which are not particularly limited, include a plastic film having no an ink absorbing layer, base materials such as paper coated with a plastic, or to which a plastic film is attached. Examples of the plastic described here include polyvinyl chloride, polyethylene terephthalate, polycarbonate, polystyrene, polyurethane, polyethylene, and polypropylene.

Here, “low absorbent recording medium” and “non-absorbent recording medium” refer to a recording medium of which the water absorption amount from the start of contact until 30 msec is equal to or less than 10 mL/m² according to the Bristow method. The Bristow method is the most widely used method as a method of measuring a liquid absorption amount in a short time, and is also employed by the Japan Technical Association of the Pulp and Paper Industry (JAPAN TAPPI). The details of the testing method are described in the standard No. 51 “Paper and Cardboard—Liquid Absorbency Test Method—Bristow Method” of the “JAPAN TAPPI Paper and Pulp Test Method 2000 Edition”.

### Ink Jet Ink Set

The ink jet ink set according to the embodiment is provided with the above-described ink jet ink composition which is a clear ink, water, polymer fine particles, and an ink jet ink composition for coloring including a colorant. When such an ink set is used, it is possible to obtain a recorded material in which the clear ink makes a color that the color ink (ink jet ink composition for coloring) shows a high gloss color.

### Ink Jet Ink Composition Being Clear Ink

As the ink jet ink composition which is a clear ink, the same as described above can be used. Moreover, the ink jet ink composition which is a clear ink does not include a coloring material.

### Ink Jet Ink Composition for Coloring

The ink jet ink composition for coloring include water, polymer fine particles, and a coloring material. As the water and the polymer fine particles, which are not particularly limited, the same as described above can be exemplified. In addition, the ink jet ink composition for coloring can include the first surfactant, and the acryl-based surfactant. When the ink jet ink composition for coloring includes the first surfactant, and the acryl-based surfactant, there is a tendency that gloss of the obtained recorded material is further improved. As the siloxane-based surfactant, the fluorine-based surfactant, and the acryl-based surfactant, which are not particularly limited, the same as described above can be exemplified.

### Coloring Material

As the coloring material, which is not particularly limited, the following pigments are exemplified.

Examples of the carbon black used for the black ink, which are not particularly limited, include No. 2300, No. 900, MCF 88, No. 33, No. 40, No. 45, No. 52, MA 7, MA 8, MA 100, No. 2200B and the like (hereinbefore, manufactured by Mitsubishi Chemical Corporation), Raven 5750, Raven 5250, Raven 5000, Raven 3500, Raven 1255, Raven 700 and the like (hereinbefore, manufactured by Columbia carbon Ltd.), Regal 400R, Regal 330R, Regal 660R, Mogul L, Monarch 700, Monarch 800, Monarch 880, Monarch 900, Monarch 1000, Monarch 1100, Monarch 1300, Monarch1400 and the like (manufactured by CABOT JAPAN K. K.), Color Black FW1, Color Black FW2, Color Black FW2V, Color Black FW18, Color Black FW200, Color Black S150, Color Black 5160, Color Black 5170, Printex 35, Printex U, Printex V, Printex 140U, Special Black 6, Special Black 5, Special Black 4A and Special Black 4 (hereinbefore, manufactured by Degussa).

Examples of the pigment used in a white ink, which are not particularly limited, include C. I. Pigment White 6, 18, and 21.

Examples of the pigment used in the yellow ink, which are not particularly limited, include C. I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of the pigment used in the magenta ink, which are not particularly limited, include C. I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, and C. I. Pigment Violet 19, 23, 32, 33, 36, 38, 43 and 50.

Examples of the pigment used in the cyan ink, which are not particularly limited, include C. I. Pigment Blue 1, 2, 3, 15, 15:1, 15:2, 15:3, 15:34, 15:4, 16, 18, 22, 25, 60, 65 and 66, and C. I. Vat Blue 4 and 60.

In addition, examples of the pigments other than the magenta, the cyan, and the yellow, which are not particularly limited, include C. I. Pigment Green 7 and 10, C. I. Pigment Brown 3, 5, 25 and 26, and C. I. Pigment Orange 1, 2, 5, 7, 13, 14, 15, 16, 24, 34, 36, 38, 40, 43 and 63.

### Ink Jet Recording Method Using Ink Jet Ink Set

The ink jet recording method using the ink jet ink set according to the embodiment has a first step of applying to a recording medium by discharging the ink jet ink composition for coloring provided in the above-described ink jet ink set from nozzles of a first head, and a second step of applying to at least a part of the ink jet ink composition for coloring applied onto the recording medium by discharging the ink jet ink composition which is the clear ink provided to the above-describe ink jet ink set from nozzles of a second head. Thus, it is possible to obtain a recorded material in which a clear ink makes a color that a color ink (ink jet ink composition for coloring) shows a high gloss color.

### Treatment Solution Applying Step

The ink jet recording method using the ink jet ink set according to the embodiment may have a treatment solution applying step in which a treatment solution including a reactant which aggregates components included in the ink jet ink composition for coloring or thickens the ink jet ink composition for coloring is applied to the recording medium, before the first step. Thus, by having the pretreatment step, it is possible to improve poor embedment (repellence, line unevenness) of a solid image in the low-absorbent recording medium and the non-absorbent recording medium. However, since the pigment or the resin in ink is aggregated by the treatment solution, and by this, the apparent particle diameter increases, the image quality becomes the matte tone. Therefore, by having the pretreatment step before the above-described step, mat-toning due to the treatment solution can be reduced, and therefore, the use of the ink composition according to the embodiment is effective.

### First Step

The first step is a step of applying to the recording medium by discharging the ink jet ink composition for coloring provided in the above-described ink jet ink set from nozzles of the first head. The ink jet ink composition for coloring applied to the recording medium may be dried. In the recording method according to the embodiment, the clear ink is applied in the second step, and therefore, it is not necessary for an ink film of the ink jet ink composition for coloring to be smooth or to have gloss, and there may be unevenness in the dried ink film. From the viewpoint of further increasing gloss of the recorded material after recording, it is preferable to increase gloss of the colored ink film in the first step.

### Second Step

The second step is a step of applying to at least a part of the ink jet ink composition for coloring applied onto the recording medium by discharging the ink jet ink composition which is a clear ink provided in the above-described ink jet ink set from nozzles of the second head. Thus, it is possible to maintain a smooth ink film surface, and to obtain a recorded material with higher glossiness by the wet-spreading property and the leveling property which a surfactant exhibits.

### Recording Resolution

The recording resolution of an image obtained by the first and/or the second step is preferably the same range as the recoding resolution in the ink jet recording method using the ink jet ink described above, respectively. Here, the nozzle density in the first direction refers to a nozzle density of the head used in the first step, in the first step, and a nozzle density of the head used in the second step, in the second step. The recording resolution of an image obtained by the first step and the recording resolution of an image obtained by the second step may not be the same. For example, the recording resolution in the first direction of an image obtained by the second step is preferably equal to or less than four times the nozzle density in the first direction of the head used in the second step.

### Recording Method

While the first head and the second head change the position relative with respect to the recording medium, recording is preferably carried out by performing one scan for discharging the ink jet ink composition for coloring and the ink jet ink composition which is a clear ink in the area of the recording medium opposite to the first head and the second head. That is, it is preferable to perform recording by the line system in a single pass. When performing recording by the line system, the time difference between implantations becomes the smallest, and thus the recording speed tends to be excellent. In a case of the line system, the recording resolution (dpi) in the first direction of an image is usually one time the nozzle density (dpi) in the first direction.

### EXAMPLES

Hereinafter, the invention will be more specifically described using Examples and Comparative Examples. The invention is not limited to these Examples.

### Material for Ink Composition

The main materials for the ink composition used in the following Examples and Comparative Examples are as follows.

### Coloring Material

### C. I. Pigment Blue 15:3 (P. B 15:3)

### Polymer Fine Particles

Styrene-acryl-based emulsion (product name: JONCRYL 538J, manufactured by BASF Corp.)

### Penetrating Agent

1,2-hexanediol

### Moisturizing Agent

Propylene glycol

### Surfactant

Siloxane-based surfactant (BYK348, manufactured by BYK Japan KK)
Siloxane-based surfactant (BYK349, manufactured by BYK Japan KK)
Fluorine-based surfactant (FS-300, manufactured by DuPont)
Acryl-based surfactant (BYK381, manufactured by BYK Japan KK)
Acryl-based surfactant (BYK361N, manufactured by BYK Japan KK)
Acetylene glycol-based surfactant (DF110D, manufactured by Air Products and Chemicals, Inc.)

### Preparation of Ink Composition

Each material was mixed according to the composition (% by mass) shown in Table 1 below, and sufficiently stirred, thereby obtaining each ink composition.

TABLE 1

| | | Clear ink | | | | | | | | | |
|---|---|---|---|---|---|---|---|---|---|---|---|
| Ink composition | | 1 | 2 | 3 | 4 | 5 | 6 | 7 | 8 | 9 | 10 |
| Polymer fine | Styrene-acryl-based | 10.0 | 10.0 | 10.0 | 10.0 | 10.0 | 10.0 | 10.0 | 10.0 | 10.0 | 10.0 |
| particles | emulsion (solid content) | | | | | | | | | | |
| Pigment | P.B 15:3 (solid content) | | | | | | | | | | |
| Penetrating | 1,2-Hexanediol | 5.0 | 5.0 | 5.0 | 5.0 | 5.0 | 5.0 | 5.0 | 5.0 | 5.0 | 5.0 |
| agent | | | | | | | | | | | |
| Moisturizing | Propylene glycol | 20.0 | 20.0 | 20.0 | 20.0 | 20.0 | 20.0 | 20.0 | 20.0 | 20.0 | 20.0 |
| agent | | | | | | | | | | | |
| Surfactant | Siloxane-based surfactant | 0.8 | 0.2 | 0.2 | | 0.8 | | | 1.0 | | 0.5 |
| | (BYK 348) | | | | | | | | | | |
| | Siloxane-based surfactant | | | | | | 0.8 | | | | |
| | (BYK 349) | | | | | | | | | | |
| | Fluorine-based surfactant | | | | 0.8 | | | | | | |
| | (FS-300) | | | | | | | | | | |
| | Acryl-based surfactant | 0.2 | 0.8 | 0.1 | 0.2 | | 0.2 | 0.2 | | 1.0 | |
| | (BYK 381) | | | | | | | | | | |
| | Acryl-based surfactant | | | | | 0.2 | | | | | |
| | (BYK 361N) | | | | | | | | | | |
| | Acetylene glycol-based | | | | | | | 0.8 | | | 0.5 |
| | surfactant (DF110D) | | | | | | | | | | |
| Balance | Water | Balance | Balance | Balance | Balance | Balance | Balance | Balance | Balance | Balance | Balance |

| | | | | | | | | | | |
|---|---|---|---|---|---|---|---|---|---|---|
| Total | 100 | 100 | 100 | 100 | 100 | 100 | 100 | 100 | 100 | 100 |
| Total content A | 1.0 | 1.0 | 0.3 | 1.0 | 1.0 | 1.0 | 0.2 | 1.0 | 1.0 | 0.5 |
| Ratio B | 4.0 | 0.3 | 2.0 | 4.0 | 4.0 | 4.0 | 0.0 | — | 0.0 | — |

| | | Color ink | | | | | |
|---|---|---|---|---|---|---|---|
| Ink composition | | 1 | 2 | 3 | 4 | 5 | 6 |
| Polymer fine | Styrene-acryl-based | 3.0 | 3.0 | 3.0 | 3.0 | 3.0 | 3.0 |
| particles | emulsion (solid content) | | | | | | |
| Pigment | P.B 15:3 (solid content) | 5.0 | 5.0 | 5.0 | 5.0 | 5.0 | 5.0 |
| Penetrating | 1,2-Hexanediol | 5.0 | 5.0 | 5.0 | 5.0 | 5.0 | 5.0 |
| agent | | | | | | | |
| Moisturizing | Propylene glycol | 20.0 | 20.0 | 20.0 | 20.0 | 20.0 | 20.0 |
| agent | | | | | | | |
| Surfactant | Siloxane-based surfactant | 0.6 | 0.4 | | 1.0 | | |
| | (BYK 348) | | | | | | |
| | Siloxane-based surfactant | | | | | | |
| | (BYK 349) | | | | | | |
| | Fluorine-based surfactant | | | 0.6 | | | |
| | (FS-300) | | | | | | |
| | Acryl-based surfactant | 0.4 | 0.6 | 0.4 | | | 1.0 |
| | (BYK 381) | | | | | | |
| | Acryl-based surfactant | | | | | | |
| | (BYK 361N) | | | | | | |
| | Acetylene glycol-based | | | | | 1.0 | |
| | surfactant (DF110D) | | | | | | |
| Balance | Water | Balance | Balance | Balance | Balance | Balance | Balance |

| | | | | | | |
|---|---|---|---|---|---|---|
| Total | 100 | 100 | 100 | 100 | 100 | 100 |
| Total content A | 1.0 | 1.0 | 1.0 | 1.0 | 0.0 | 1.0 |
| Ratio B | 1.5 | 0.7 | 1.5 | — | — | 0.0 |

Total content A: total content of siloxane-based surfactant, fluorine-based surfactant, and acry-based surfactant
Ratio B: (content of first surfactant)/(content of acryl-based surfactant)

### Ink Jet Recording Method

### Examples 1 to 11 and Comparative Examples 1 to 5

### Gloss of Recorded Material Obtained by Color Inks (No Treatment Solution)

As an ink jet recording apparatus, a remodeled PX-G930 (manufactured by Seiko Epson Corporation) equipped with a head having a nozzle density of 180 dpi was used. The color inks prepared above were discharged to be applied on a recording medium (N mirror cast paper, glossiness of the recording medium: 65). After the recording medium was thoroughly dried by heating, the obtained solid patterns were measured using a measurement apparatus of glossiness (GM-268 Plus manufactured by Konica Minolta, Inc.). Moreover, the applied amount of the color inks was set to 8 mg/inch². In addition, each solid pattern in which a recording resolution was changed within 180 dpi×1 to 8 was obtained. From the results of the glossiness, the solid patterns were evaluated according to the following evaluation criteria. It can be considered that when the numerical value of the glossiness was higher, a solid pattern showing more excellent glossiness was obtained (hereinafter the same).

Evaluation Criteria: glossiness Gs: measurement angle 20°
A: equal to or more than 45
B: equal to or more than 40 and less than 45
C: equal to or more than 35 and less than 40
D: equal to or more than 30 and less than 35
E: equal to or more than 25 and less than 30
F: equal to or more than 20 and less than 25
G: equal to or more than 15 and less than 20
H: less than 15

### Gloss of Recorded Material Obtained by Color Inks (with Treatment Solution)

Solid patterns were obtained in the same operation as in the above-described “Gloss of Recorded Material Obtained by Color Inks (no treatment solution)” except that a treatment solution was applied on the recording medium (N mirror cast paper, glossiness of the recording medium: 65) by the applied amount of 0.5 g/m², and after the recording medium was thoroughly dried by heating, color inks were applied. The glossiness of the obtained solid patterns was measured using the measurement apparatus of glossiness (GM-268 Plus manufactured by Konica Minolta, Inc.). From the results of the glossiness, the solid patterns were evaluated according to the following evaluation criteria. Moreover, as the treatment solution, a treatment solution including 1.6% of magnesium sulfate heptahydrate, 0.6% of the surfactant BYK-348, and purified water as the balance (total 100%) was prepared and used.

Evaluation Criteria: glossiness Gs: measurement angle 20°
A: equal to or more than 45
B: equal to or more than 40 and less than 45
C: equal to or more than 35 and less than 40
D: equal to or more than 30 and less than 35
E: equal to or more than 25 and less than 30
F: equal to or more than 20 and less than 25
G: equal to or more than 15 and less than 20
H: less than 15

### Gloss of Recorded Material Obtained by Color Inks and Clear Inks (No Treatment Solution)

As the ink jet recording apparatus, the remodeled PX-G930 (manufactured by Seiko Epson Corporation) equipped with a head having a nozzle density of 180 dpi was used. First, the color inks prepared above were discharged to be applied on a recording medium (N mirror cast paper, glossiness of the recording medium: 65). The recording medium was thoroughly dried by heating, and the clear inks prepared above were discharged to be applied on an ink film of the color inks on the recording medium. The glossiness of the obtained solid patterns was measured using the measurement apparatus of glossiness (GM-268 Plus manufactured by Konica Minolta, Inc.). Moreover, the applied amount of the color inks was set to 8 mg/inch², and the applied amount of the clear inks was also set to 8 mg/inch². In addition, each solid pattern in which a recording resolution was changed within 180 dpi×1 to 8 was obtained. From the results of the glossiness, the solid patterns were evaluated according to the following evaluation criteria.

Evaluation criteria: glossiness Gs before and after applying clear inks: measurement angle 20°
A: glossiness value after applying clear inks=glossiness before applying x equal to or greater than 120%
B: glossiness value after applying clear inks=glossiness before applying x equal to or greater than 115% to less than 120%
C: glossiness value after applying clear inks=glossiness before applying x equal to or greater than 110% to less than 115%
D: glossiness value after applying clear inks=glossiness before applying x less than 110%

### Gloss of Recorded Material Obtained by Color Inks and Clear Inks (with Treatment Solution)

Solid patterns were obtained in the same operation as in the above-described “Gloss of Recorded Material Obtained by Color Ink and Clear Inks (no treatment solution)” except that a treatment solution was applied on the recording medium (N mirror cast paper, glossiness of the recording medium: 65) by the applied amount of 0.5 g/m², and after the recording medium was thoroughly dried by heating, color inks were applied. The glossiness of the obtained solid patterns was measured using the measurement apparatus of glossiness (GM-268 Plus manufactured by Konica Minolta, Inc.). From the results of the glossiness, the solid patterns were evaluated according to the following evaluation criteria. Moreover, as the treatment solution, a treatment solution including 1.6% of magnesium sulfate heptahydrate, 0.6% of the surfactant BYK-348, and purified water as the balance (total 100%) was prepared and used.

Evaluation criteria: glossiness Gs before and after applying clear inks: measurement angle 20°
A: glossiness value after applying clear inks=glossiness before applying x equal to or greater than 120%
B: glossiness value after applying clear inks=glossiness before applying x equal to or greater than 115% to less than 120%
C: glossiness value after applying clear inks=glossiness before applying x equal to or greater than 110% to less than 115%
D: glossiness value after applying clear inks=glossiness before applying x less than 110%

TABLE 2

| | | | | | | | Comparative | | |
|---|---|---|---|---|---|---|---|---|---|
| | | | | Example | | | example | | |
| | | | | 1 | 2 | 3 | 1 | 2 | 3 |
| | Nozzle | Recording resolution | Recording resolution | Color ink NO. | | | | | |
| | resolution | (horizontal direction) | (vertical direction) | 1 | 2 | 3 | 4 | 5 | 6 |
| There is no reaction | 180 dpi | 180 dpi | 180 dpi | A | A | A | C | E | C |
| solution | (vertical) | 180 dpi × 2 | 180 dpi × 2 | A | B | A | D | E | C |
| | | 180 dpi × 4 | 180 dpi × 4 | A | B | A | D | F | D |
| | | 180 dpi × 8 | 180 dpi × 8 | B | D | B | F | G | E |
| There is reaction solution | 180 dpi | 180 dpi | 180 dpi | F | G | F | G | G | G |
| (magnesium sulfate) | (vertical) | 180 dpi × 2 | 180 dpi × 2 | F | G | F | G | H | H |
| | | 180 dpi × 4 | 180 dpi × 4 | G | H | G | H | H | H |
| | | 180 dpi × 8 | 180 dpi × 8 | H | H | H | H | H | H |

TABLE 3

| | | | | Example | | | | | | | | | | | Comparative example | | | | |
|---|---|---|---|---|---|---|---|---|---|---|---|---|---|---|---|---|---|---|---|
| | | | | 4 | 5 | 6 | 7 | 8 | 9 | 10 | 11 | 12 | 13 | 14 | 4 | 5 | 6 | 7 | 8 |
| | | | | Clear ink NO. | | | | | | | | | | | | | | | |
| | | | Recording | 1 | 1 | 2 | 1 | 1 | 5 | 6 | 3 | 4 | 1 | 1 | 7 | 8 | 9 | 10 | 7 |
| | Nozzle | Recording resolution | resolution | Color ink NO. | | | | | | | | | | | | | | | |
| | resolution | (horizontal direction) | (vertical direction) | 1 | 2 | 1 | 3 | 4 | 1 | 1 | 1 | 1 | 5 | 6 | 1 | 1 | 1 | 1 | 5 |
| There is no | 180 dpi | 180 dpi | 180 dpi | A | A | A | A | A | A | A | B | A | B | B | C | C | D | C | C |
| reaction | (vertical) | 180 dpi × 2 | 180 dpi × 2 | A | B | B | A | B | A | A | B | A | B | B | D | D | D | D | D |
| solution | | 180 dpi × 4 | 180 dpi × 4 | B | B | B | B | B | B | A | B | B | B | B | D | D | D | D | D |
| | | 180 dpi × 8 | 180 dpi × 8 | C | C | C | C | C | C | B | D | C | C | C | D | D | D | D | D |
| There is | 180 dpi | 180 dpi | 180 dpi | A | A | A | A | B | A | A | B | A | B | A | C | C | C | C | C |
| reaction | (vertical) | 180 dpi × 2 | 180 dpi × 2 | A | A | A | A | B | A | A | B | A | B | B | C | C | C | C | C |
| solution | | 180 dpi × 4 | 180 dpi × 4 | A | A | B | A | B | A | A | B | A | B | B | C | C | D | C | D |
| (magnesium | | 180 dpi × 8 | 180 dpi × 8 | B | B | B | B | B | B | A | B | B | B | B | C | D | D | D | D |
| sulfate) | | | | | | | | | | | | | | | | | | | |

On the basis of what is described above, it was found that the recorded material obtained in the examples has excellent glossiness. In particular, in a case where the clear inks are used, it was possible to obtain excellent gloss even when the treatment solution is used. In addition, it was found that even in a case where only the color inks are used, a recorded material having excellent gloss can be obtained when the treatment solution is not used.

The entire disclosure of Japanese Patent Application No. 2013-179110, filed Aug. 30, 2013 is expressly incorporated by reference herein.

What is claimed is:

1. An ink jet ink composition, comprising:
water;
polymer fine particles;
one or more types selected from a group consisting of a siloxane-based surfactant, and a fluorine-based surfactant; and
an acryl-based surfactant.

2. The ink jet ink composition according to claim 1,
wherein a total content of one or more types selected from the group consisting of the siloxane-based surfactant and the fluorine-based surfactant, and the acryl-based surfactant is 0.05% by mass to 5% by mass with respect to 100% by mass of the ink jet ink composition.

3. The ink jet ink composition according to claim 1,
wherein a ratio of a content of one or more types selected from the group consisting of the siloxane-based surfactant and the fluorine-based surfactant with respect to a content of the acryl-based surfactant is 0.1 to 10.

4. The ink jet ink composition according to claim 1,
wherein the siloxane-based surfactant includes polyether-modified polydimethylsiloxane.

5. The ink jet ink composition according to claim 1,
wherein the siloxane-based surfactant includes polyether-modified polydimethylsiloxane represented by the following General Formula (1). 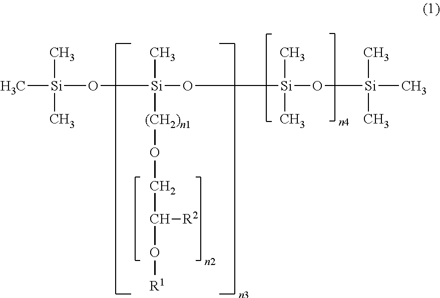
(In Formula (1), R¹ each independently represents a hydrogen atom or an alkyl group having 1 to 4 carbon atoms, R² each independently represents a hydrogen atom or an alkyl group having 1 to 4 carbon atoms, a monovalent group having a cationically polymerizable group or a monovalent group having an ethylenically unsaturated group, n₁ and n₂ each independently is an integer of 1 to 5, n₃ is an integer of 1 to 30, n₄ is an integer of 1 to 70, and n₃/n₄ is less than 1.)

6. The ink jet ink composition according to claim 1 which is a clear ink.

7. An ink jet ink set, comprising:
the ink jet ink composition according to claim 6; water;
polymer fine particles; and
an ink jet ink composition for coloring including a colorant.

8. The ink jet ink set according to claim 7,
wherein the ink jet ink composition for coloring includes one or more types selected from a group consisting of a siloxane-based surfactant, and a fluorine-based surfactant;
and an acryl-based surfactant.

9. An ink jet recording method, comprising:
applying the ink jet ink composition according to claim 1 to a recording medium by discharging the ink jet ink composition from nozzles of a head.

10. An ink jet recording method, comprising:
applying the ink jet ink composition according to claim 2 to a recording medium by discharging the ink jet ink composition from nozzles of a head.

11. An ink jet recording method, comprising:
applying the ink jet ink composition according to claim 3 to a recording medium by discharging the ink jet ink composition from nozzles of a head.

12. An ink jet recording method, comprising:
applying the ink jet ink composition according to claim 4 to a recording medium by discharging the ink jet ink composition from nozzles of a head.

13. An ink jet recording method, comprising:
applying the ink jet ink composition according to claim 5 to a recording medium by discharging the ink jet ink composition from nozzles of a head.

14. The ink jet recording method according to claim 9, wherein the head has a nozzle array in which the nozzles are lined up in a first direction, and
in the applying, the head discharges such that a recording resolution (dpi) in the first direction of an image is equal to or less than four times a nozzle density (dpi) in the first direction.

15. The ink jet recording method according to claim 9, further comprising applying a treatment solution including a reactant which aggregates components included in the ink jet ink composition or thickens the ink jet ink composition to the recording medium, before the applying of the ink jet ink composition.

16. The ink jet recording method according to claim 9,
wherein recording is performed by discharging the ink jet ink composition in an area of the recording medium opposite to the head with one scan of the head with respect to the recording medium.

17. An ink jet recording method, comprising:
firstly applying the ink jet ink composition for coloring provided in the ink jet ink set according to claim 7 to a recording medium by discharging the ink jet ink composition from nozzles of a first head; and
secondly applying the ink jet ink composition which is a clear ink provided to the ink jet ink set to at least a part of the ink jet ink composition for coloring applied to the recording medium by discharging the ink jet ink composition from nozzles of a second head.

18. The ink jet recording method according to claim 17, wherein the first head and the second head have nozzle arrays in which the nozzles are lined up in the first direction, and
a recording resolution (dpi) in the first direction of an image obtained in the secondly applying is equal to or less than four times a nozzle density (dpi) in the first direction of the second head.

19. The ink jet recording method according to claim 17, further comprising applying a treatment solution including a reactant which aggregates components included in the ink jet ink composition for coloring or thickens the ink jet ink composition for coloring to the recording medium, before the firstly applying.

20. The ink jet recording method according to claim 17,
wherein recording is performed by discharging the ink jet ink composition which is the ink jet ink composition for coloring and the clear ink in an area of the recording medium opposite to the first head and the second head with one scan of the first head and the second head with respect to the recording medium.
